(19) United States
(12) Patent Application Publication
(10) Pub. No.: US 2006/0180629 A1
(43) Pub. Date: Aug. 17, 2006

(54) Close connection device of lid for a used-nail cylinder of a rivet gun

(76) Inventor: Yu-Ching Lin, Taipei (TW)

Correspondence Address: TROXELL LAW OFFICE PLLC, Suite 1404,, 5205 Leesburg Pike,, Falls Church, VA, 22041, US

(21) Appl. No.: 11/059,399

(22) Filed: Feb. 17, 2005

(51) Int. Cl. B25C 1/00; B25C 1/04

(52) U.S. Cl. 227/14; 227/156

(57) ABSTRACT

A close connection device of lid for a used-nail cylinder of a rivet gun, in which rear end of the body portion of the rivet gun is mounted with a used-nail cylinder, and the used-nail cylinder has an outer lid, which has a cylinder-shaped stub furnished with a ring groove for receiving an O-shaped ring; the inner end of the used-nail cylinder is furnished with a guide ring and a limit ring groove; by means of a position difference between the O-shaped ring and the limit ring groove, the O-shaped ring and the limit ring groove, the O-shaped ring on the cylinder-shaped stub can be guided along a guide ring in place; finally, an eccentric position will take place between the O-shaped ring and the limit ring groove so as to provide the outer lid and the used-nail cylinder with a close and a click connection and to prevent from detachment each other.

### BACKGROUND OF THE INVENTION

1. Field of the Invention

This invention relates to a rivet gun, and particularly to a rivet gun with a close connection device of lid for a used-nail cylinder.

2. Description of the Prior Art

In a conventional rivet gun, the used-nail cylinder is usually mounted on the rear end of the body portion thereof; a space in the used-nail cylinder is used for storing used nail before being discarded; after the used-nail cylinder is full of used nails, it can be unscrewed from the body portion to discard the used nails.

The used-nail cylinder screwed on the rear end of the body portion of the rivet gun would badly affect the attachment thereof, i.e., the used-nail cylinder is susceptible to detachment from the body portion during working with a pneumatic power; if the used-nail cylinder is screwed in place too tight, it would be rather difficult to remove; moreover, if the used-nail cylinder is screwed and unscrewed quite often, the threads thereof made of plastic material would be subject to damage.

### SUMMARY OF THE INVENTION

The prime object of the present invention is to provide a close connection device of lid for a used-nail cylinder of a rivet gun, in which one end of the used-nail cylinder is screwed together with the body portion; as soon as the used-nail cylinder is full of used nails, the outer lid can be removed to discard all used nails.

Another object of the present invention is to provide a close connection device of lid for used-nail cylinder of a rivet gun, in which the outer surface of the outer lid is furnished with a granular surface for easy grip with hand; one end of the outer lid has a cylinder-shaped stub furnished with an O-shaped ring, which is in close contact with the ring groove to facilitate the outer lid to be pulled and removed.

Still another object of the present invention is to provide a close connection device of lid for a used-nail cylinder of a rivet gun, in which the inner end of the used-nail cylinder is furnished with a limit ring groove; a given distance between the limit ring groove and the end surface of the used-nail cylinder is designed in advance; when the cylinder-shaped stub of the outer lid is moved towards the guide ring in the cylinder, the two surfaces thereof will be in close contact; as soon as the O-shaped ring is set into the limit ring groove, the two parts will be assembled in place closely and firmly.

A further object of the present invention is to provide a close connection device of lid for a used-nail cylinder of a rivet gun, in which the O-shaped ring is mounted into the limit ring groove by means of a center-point position difference between the O-shaped ring and the limit ring groove to have the O-shaped ring moved along the guide ring, and to provide an eccentric positioning condition between the O-shaped ring and the limit ring groove.

### BRIEF DESCRIPTION OF THE DRAWINGS

FIG. 1 is a perspective view of the present invention.

FIG. 2 is a disassembled view of the used-nail cylinder of the present invention.

FIG. 3 is a sectional view of the used-nail cylinder of the present invention.

FIG. 4 is a plan view of the present invention, showing the used-nail cylinder separated from the outer lid.

FIG. 5 is a plan view of the present invention, showing the used-nail cylinder and the outer lid being assembled.

FIG. 6 is a plan view of the present invention, showing the used-nail cylinder and the outer lid being assembled in place.

FIG. 7 is a sectional vie of the present invention, showing the structure of the used-nail cylinder being clicked together with the outer lid.

FIG. 8 is an enlarged sectional view of the present invention, showing the structure of the used-nail cylinder being clicked together with the outer lid.

### DETAILED DESCRIPTION OF THE PREFERRED EMBODIMENT

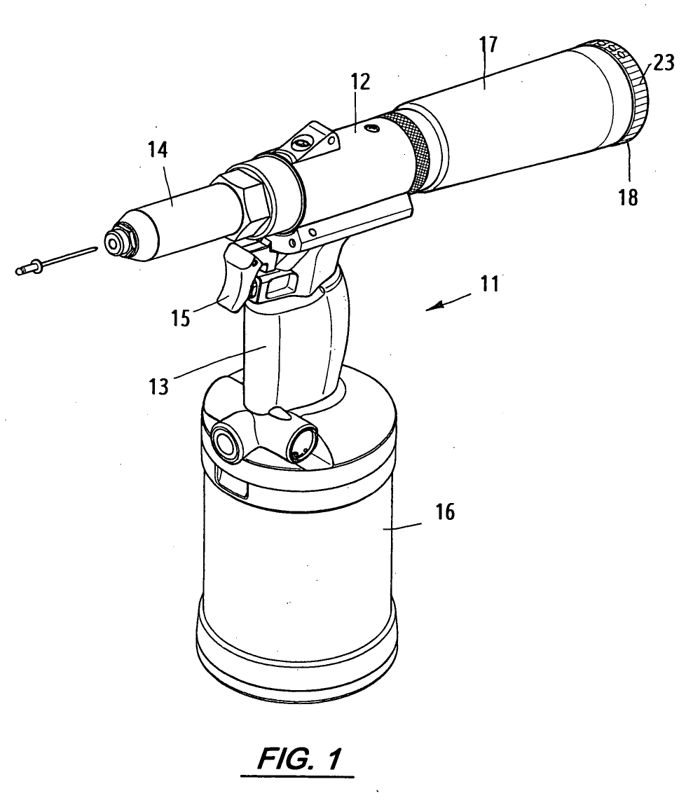

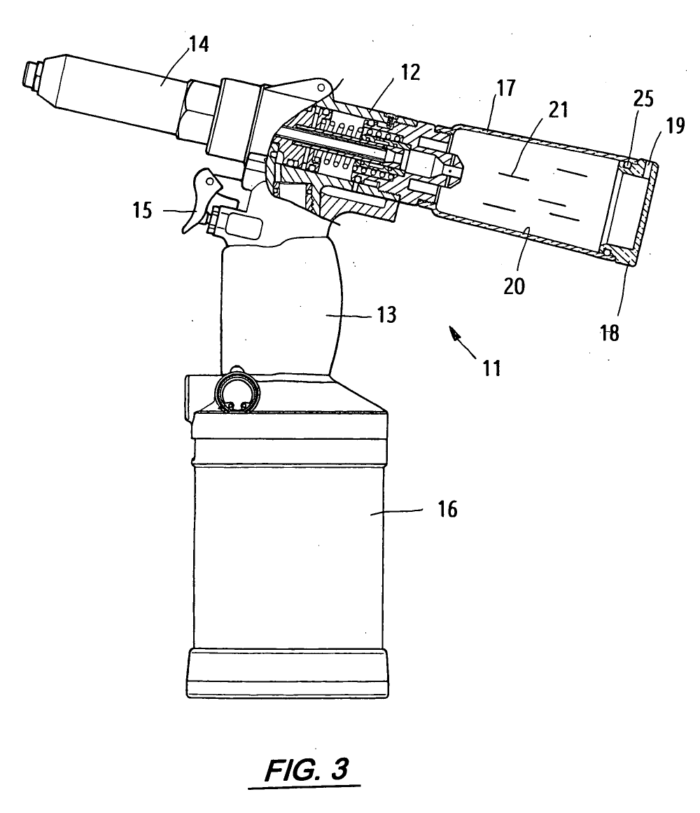

This invention relates to a close connection device of lid for a used-nail cylinder of a rivet gun; as shown in FIGS. 1 to 3, the lower portion of the body portion 12 of the rivet gun 11 is furnished with a handle 13, a trigger 15 and a pressure tank 16; the front end of the body 12 is mounted with a pull rod assembly 14, while the rear end thereof is mounted with a used-nail cylinder 17. A pressure air is filled into the pressure tank 16; by means of a piston, the pressure air is converted into a hydraulic power for riveting work; the broken used-nail stem 21 will be sucked, by means of a vacuum suction force, into the used-nail cylinder 17 for temporary storage; the used nails therein can be discarded upon the outer lid 18 of the used-nail cylinder 17 being opened.

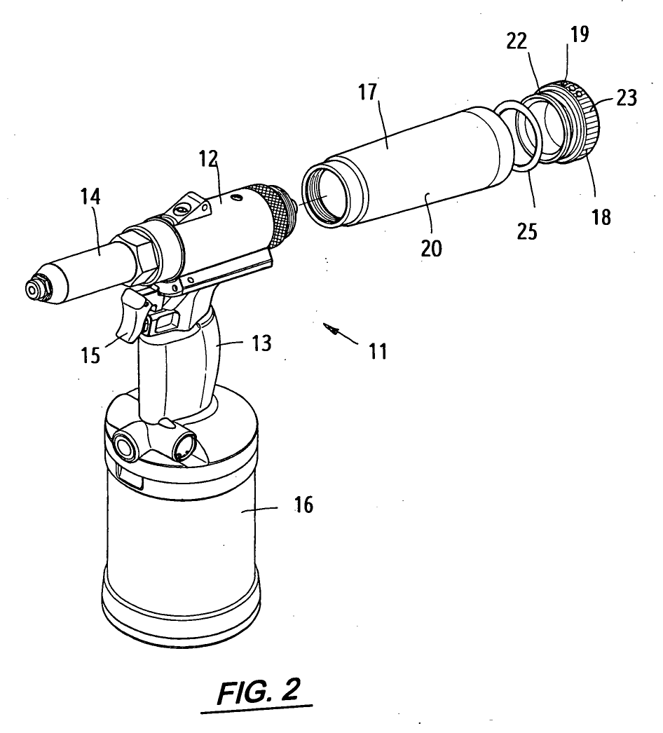

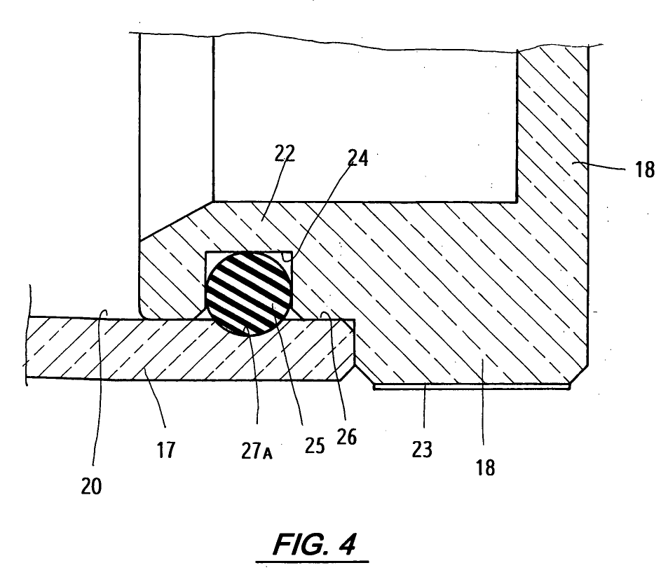

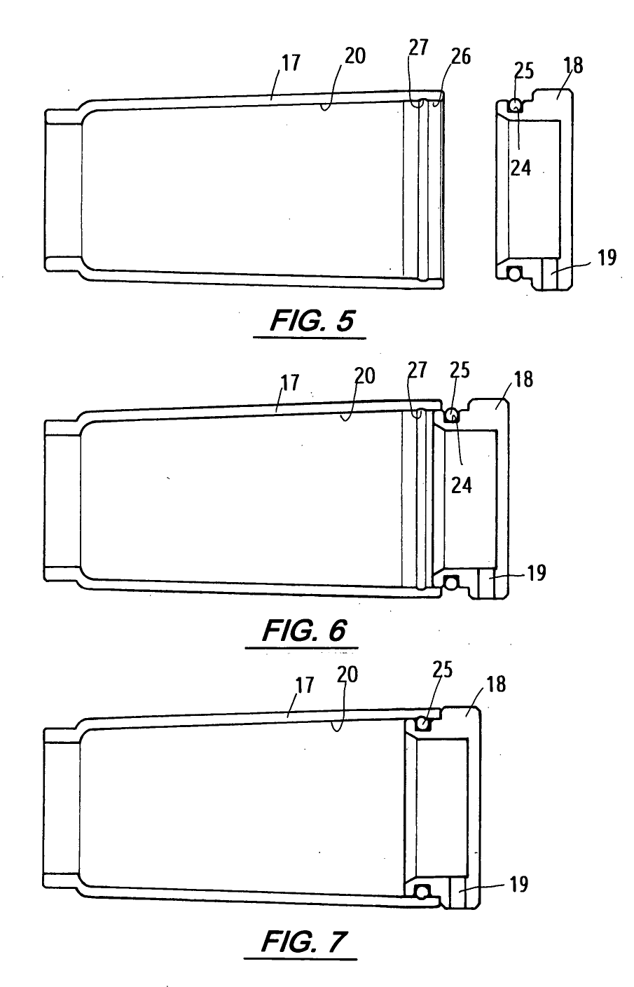

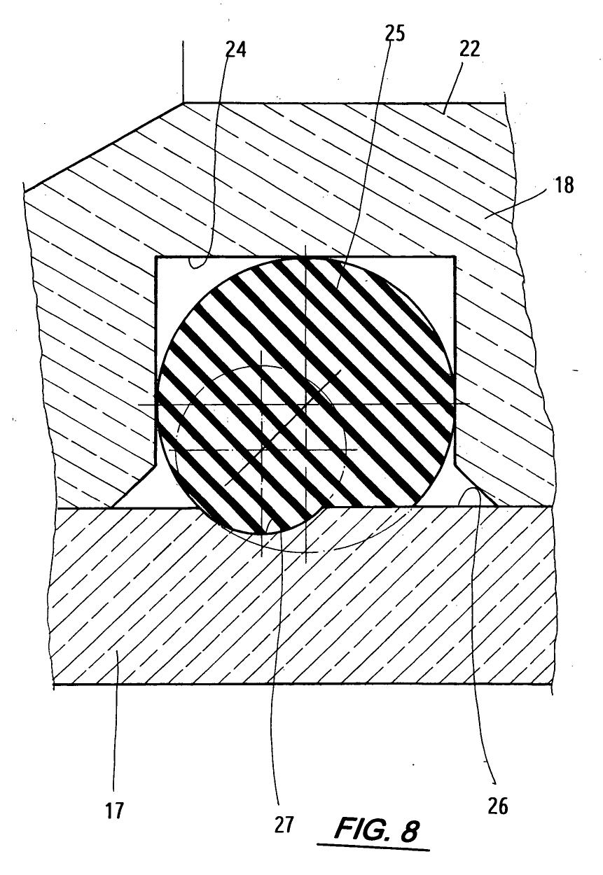

Referring to FIGS. 2 to 7, the body portion 12 of the rivet gun 11 is screwed together with one end of the used-nail cylinder 17; the inner surface 20 of the used-nail cylinder 17 is a round surface; the outer end of the inner surface 20 is furnished with a guide ring 26, which has a suitable length to fit to a positioning distance of a cylinder-shaped stub 22 of the outer lid 18; the inner end of the guide ring 26 is furnished with a limit ring groove 27, which is used for facilitating the O-shaped ring 25 to click in place upon the outer lid 18 being connected with the used-nail cylinder.

The outer lid 18 of the used-nail cylinder 17 is furnished with a U-shaped ring groove. The outer lid 18 has a cylinder-shaped stub 22 facing to the used-nail cylinder 17; the outer end of the cylinder-shaped stub 22 is furnished with a ring to mate with the diameter of the end of the used-nail cylinder 17; the ring portion is furnished with a granular surface 23 to facilitate a hand to grip and turn the same; a plurality of exhaust holes 19 in communication with the used-nail cylinder is furnished on the granular surface 23, and such exhaust holes 19 are merely an exhaust passage for the pressure air to have the used-nail stems 21 entered into the used-nail cylinder 17.

As shown in FIG. 8, the cylinder-shaped stub 22 of the outer lid 18 has a ring groove 24 for receiving an O-shaped groove 25; the end of the inner surface 20 of the used-nail cylinder 17 is furnished with a guide ring 26 and a ring groove 27A; the ring groove 27A and the O-shaped groove 25 are in contact each other on the same center and the same diameter curve. When the outer lid 18 is mounted towards the guide ring 26 of the used-nail cylinder 17, and put in lace, the O-shaped ring 25 and the ring groove 27A will be in close contact each other; there is a gap furnished between the O-shaped ring 25 of the outer lid 18 and the ring groove 24 so as to provide a pushing space upon the outer lid 18 and the O-shaped ring 25 being mated together; however, the aforesaid pushing space would cause the outer lid 18 detached from the used-nail cylinder 17 as a result of working shake and pushing of the pressure air.

In order to facilitate the outer lid 18 and the used-nail cylinder 17 to be mated together and to prevent the same from detached each other, the center point of the O-shaped ring 25 is designed and moved inwards at an angle of 45 degrees as shown in FIGS. 6 to 8, i.e., the center point is moved inwards along an extension line to draw a circle for the ring groove 27 as shown in FIG. 8; the circular arc of the ring groove 27 must be in tangent to the circle of the O-shaped ring 25; the semi-circular surface of the ring groove 27 should be positioned inside the vertical center line of the O-shaped ring 25 so as to provide the outer surface of the O-shaped ring 25 with a guide space, and to have the outer surface of the O-shaped ring 25 set in an eccentric position to click into the ring groove 27 to maintain a detaining effect.

The outer lid 18 can be mounted in place by moving the cylinder-shaped stub 22 towards the used-nail cylinder 17, and the O-shaped ring 25 in the U-shaped ring groove 24 on the cylinder-shaped stub 22 should be guide into the guide ring 26 by pressing and pushing until the inner side of the U-shaped ring groove 24 being moved into the ring groove 27 of the used-nail cylinder 17; when the moving of the outer lid 18 is stopped, it is indicated that the O-shaped ring 25 has been moved into the center of the ring groove 27 by means of a slanting guide effect; after the outer surface of the O-shaped ring 25 is in close contact with the surface of the ring groove 27, an inward pulling force from the O-shaped ring 25 would take place to enable the outer lid 18 and the opening of the used-nail cylinder 17 to be fastened together closely.

While the invention has been described with reference to specific embodiments it must be understood that those embodiments are susceptible to many changes, substitutions, and modifications that will be readily apparent to those having ordinary skill in the art without departing from the scope and spirit of the invention.

What is claimed is:

1. A close connection device of lid for a used-nail cylinder of a rivet gun comprising a body portion and an outer lid mounted on rear end of said body portion, and features thereof are as follows:
inside of said outer lid furnished with a cylinder-shaped stub which having a ring groove on outer surface thereof for receiving an O-shaped ring; outer end of said used-nail cylinder furnished with a guide ring, of which inner surface furnished with a ring groove; said cylinder-shaped stub of said outer lid being guided into said ring groove along said guide ring in said used-nail cylinder; by means of an eccentric position effect between said O-shaped ring of said cylinder-shaped stub and said ring groove in said used-nail cylinder, said outer lid able to be clicked in position.

2. A close connection device of lid for a used-nail cylinder of a rivet gun as claimed in claim 1, wherein an eccentric position effect between said O-shape ring on said cylinder-shaped stub of said outer lid and said ring groove in said used-nail cylinder is generated by means of using a center point of said O-shaped ring to extend inwards and downwards at an angle of 45 degrees to a point as center of said ring groove and as a circular arc of said ring groove; said circular arc being in tangent to said O-shaped ring.
